(19) United States
(12) Patent Application Publication
(10) Pub. No.: US 2024/0348606 A1
(43) Pub. Date: Oct. 17, 2024

(54) PRIVATE 5G NETWORK FINGERPRINT BINDING WITH DEGRADATION MONITORING

(71) Applicants: Stephen T. Palermo, Chandler, AZ (US); Valerie J. Parker, Portland, OR (US); Patrick L. Connor, Beaverton, OR (US); Francesc Guim Bernat, Barcelona (ES); John Joseph Browne, Limerick (IE); Rajesh Poornachandran, Portland, OR (US); Marcos E. Carranza, Portland, OR (US)

(72) Inventors: Stephen T. Palermo, Chandler, AZ (US); Valerie J. Parker, Portland, OR (US); Patrick L. Connor, Beaverton, OR (US); Francesc Guim Bernat, Barcelona (ES); John Joseph Browne, Limerick (IE); Rajesh Poornachandran, Portland, OR (US); Marcos E. Carranza, Portland, OR (US)

(21) Appl. No.: 18/754,752

(22) Filed: Jun. 26, 2024

(51) Int. Cl. H04L 9/40

(52) U.S. Cl. CPC H04L 63/0876

(57) ABSTRACT

Various approaches for the verification of 5G networks, including the use of fingerprint-based IQ measurements for authentication and integrity monitoring, are discussed. In an example, a method of using fingerprints for authentication of network use includes: capturing in-phase and quadrature (IQ) data from a network connection between a user equipment (UE) and a 5G network; performing authentication of the network connection between the UE and the 5G network, by using a symbol of the IQ data as a random factor for the authentication; and monitoring the IQ data on an ongoing basis to verify the network connection between the UE and the 5G network. The method may also include creating a baseline IQ measurement from the IQ data when performing the authentication between the UE and the 5G network, and monitoring the IQ data by using a comparison of an ongoing IQ measurement to the baseline IQ measurement.

### BACKGROUND

Various approaches are being investigated for new deployments and capabilities of 5G New Radio (5G NR) networks. 5G promises significantly network densification than prior cellular network systems, and 5G NR has introduced more bands than previous wireless network standards to transmit data. Some of the approaches being investigated include how to securely deploy private, hybrid, and public 5G networks. For example, various techniques and technologies are being explored for 5G devices and infrastructure to ensure the protected and resilient utilization of 5G networks, even in degraded, intermittent, and connectivity-limited environments.

Private 5G networks introduce greater control across coverage areas including the ability to segment traffic access point names/data network names (APNs) and IP pooling based on credential types. Private 5G networks also can connect many disparate Edge devices as well as device-to-device communications. Private 5G networks can be hosted in a variety of settings, including: (1) fully on-premises, (2) cloud-based, or a (3) a hybrid-cloud model (e.g., using either a private ORAN radio unit or a quasi-private slice of a public ORAN Radio Unit).

5G standards and implementations have progressively addressed certain access security concerns, such as no longer transmitting a plain text Subscription Permanent Identifier (SUPI) that is used to secure end-to-end communications from a UE to CN. However, many private networks require more robust authentication and privacy capabilities in degraded, intermittent, and connectivity-limited environments.

### BRIEF DESCRIPTION OF THE DRAWINGS

In the drawings, which are not necessarily drawn to scale, like

numerals may describe similar components in different views. Like numerals having different letter suffixes may represent different instances of similar components. Some embodiments are illustrated by way of example, and not limitation, in the figures of the accompanying drawings in which:

FIGS. 1A and 1B depict a user equipment (mobile device) configured to communicate with private and public 5G networks, according to an example;

FIG. 2 depicts a modem configuration of a user equipment configured to communicate with private and public 5G networks, according to an example;

FIG. 3 depicts a flowchart of a data processing workflow for establishing connectivity of a user equipment and an application to a network, according to an example;

FIGS. 4A to 4D depict flowcharts of approaches for 5G network degradation monitoring and verification, based on Unique IQ fingerprint data, according to an example;

FIGS. 5A, 5B, and 5C depict respective and combined measurements of IQ fingerprint data from multiple antennas, according to examples;

FIGS. 6A and 6B depict symbols used for measurements of IQ fingerprint data, according to examples;

FIGS. 7A, 7B, and 7C depict a flowchart of monitoring and maintaining use of applications with specific networks, according to an example;

FIG. 8 depicts a data operation flow for a method for implementing and operating an AI framework for IQ fingerprint measurement collection and analysis, according to an example;

FIG. 9 depicts a flowchart of a method of using IQ fingerprint measurements for authentication of network use, according to an example;

FIG. 10A illustrates an overview of example components deployed at a compute node system, according to an example;

FIG. 10B illustrates a further overview of example components within a computing device, according to an example; and

FIG. 11 illustrates a software distribution platform to distribute software instructions and derivatives, according to an example.

### DETAILED DESCRIPTION

The following addresses technical challenges encountered with 5G New Radio (5G NR) communications technologies. The following also provides approaches for maintaining and adapting 5G NR communications, including for Private 5G network cells that are extended temporarily or permanently. Private 5G network cells may be deployed to increase network capacity, including in emergency, disaster, or rapid deployment settings, at sports arenas, large cities, or at large-scale public events, or in connection with other situations that necessitate extra capacity or mobility. Private 5G network cells may also be deployed to provide a secondary isolated network that includes additional security features and measures not available in Public 5G networks.

The following introduces improved techniques for Private 5G network security in degraded Edge situations. In one example, pure-random IQ fingerprinting and multi-factor authentication is introduced based on a binding of a user equipment to various identifiers such as a User Device ID, a Network ID, and/or an Application ID (or a combination thereof). The following also describes approaches to associate different applications on the same device with different 5G networks supported by different SIM/eSIMs. Such 5G networks can be public or private, and accessed by the same smartphone/mobile device. Thus, different apps can be selectively grouped, to cause apps to be bound to use specific networks via a specific SIM/eSIM.

In one example, a private 5G network establishes a purely random Antenna IQ Signature (referred to herein as a “Unique IQ Fingerprint” or UIQFP) that is used in conjunction with a unique Device ID and/or a unique Network ID (e.g., a SIM or other network identifier that can be generated and represented as a QR code, as an activation code, or as a certificate/certification code, used to join a particular network) and/or unique Application ID to (i) allow one-time access to information and (ii) continuously monitor for 5G O-RAN type degradation. Thus, once a temporary 5G Private Network implementation is established, authorized users will be able to gain login access for specific Apps connected to a specific Private 5G network (e.g., associated with a specific SIM slot such as SIM1, SIM2), only if the private 5G network complies with certain degradation limits. In still further examples, the unique Device ID and/or unique Network ID (e.g., an activation code, certification code, or certificate) itself can be uniquely generated based on IQ data or supplemented with a signature based on the IQ data.

In this fashion, the techniques discussed herein introduce a multi-factor binding and authentication for the use of a 5G network, based on Device and Network binding. The techniques discussed herein also leverage a capability to map specific Apps installed on the UE to specific SIM units with QoS Capability (e.g., configurable according to a QoS policy) while allowing dynamic re-mapping of connections and bindings based on telemetry and AI-driven heuristics. The additional use of IQ degradation fingerprint signatures also introduces a capability to monitor for network degradation on an ongoing basis based on IQ response deviations from a baseline packet data unit (PDU) session establishment.

The following techniques for monitoring network infrastructure and 5G NR systems are applicable to a variety of network settings and use cases. These use cases include many implementations of Private 5G networks that are deployed fully on-premises, cloud-based, or configured in a hybrid-cloud. These use cases also include future Private Network configurations as well as extensions of commercial Public Networks, including as an extended application (xAPP) in an Open RAN (O-RAN) style private 5G implementation, e.g., as part of the O-RAN RAN Intelligent Controller (RIC). Accordingly, the various reference to a “Private 5G” network are provided for purposes of explanation, and not necessarily limited to current implementations of a Private 5G network.

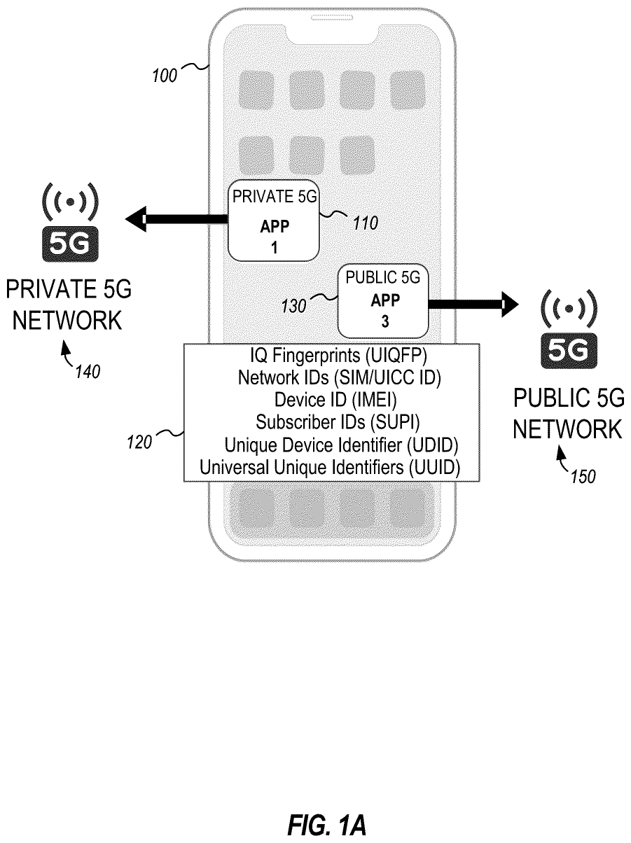

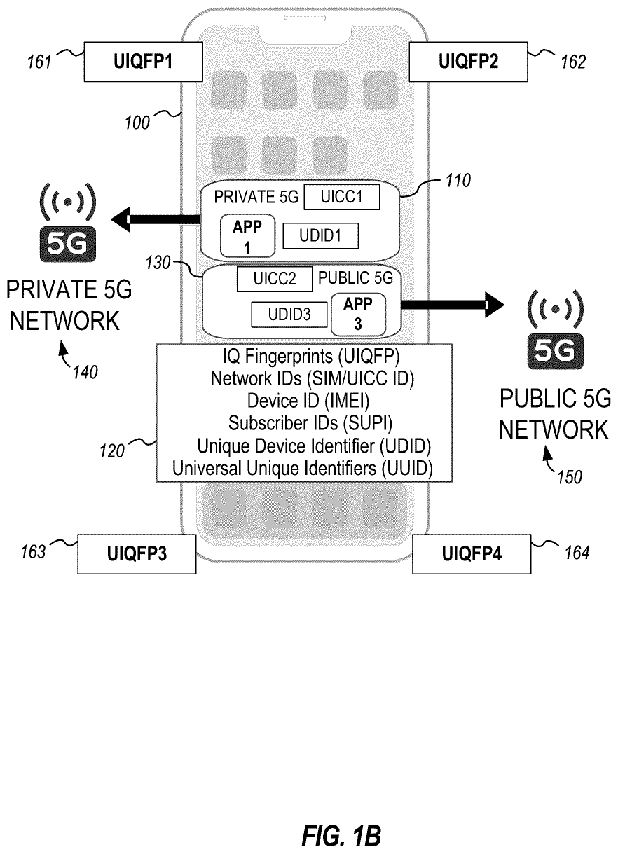

FIGS. 1A and 1B depict a user equipment configured to communicate with private and public 5G networks, based on the techniques discussed herein. FIG. 1A first provides a simplified overview of an example connectivity setting with a mobile device, e.g., 5G user equipment (UE). A UE 100 includes subscriber identity module (SIM) or electronic subscriber identity module (eSIM) slots and hardware, with respective SIMs/eSIMs being mapped to different networks. For example, a first SIM/eSIM of the UE 100 may map to a private 5G network 140, and a second SIM/eSIM of the UE 100 may map to a public 5G network 150. As used herein, a SIM “slot” refers to a particular logical or physical assignment of a discrete “unit” such as a SIM device, card, chip, or circuitry (or information on such a card, chip, or circuitry) that is assigned to connect with a network. Thus, a SIM slot does not necessarily refer to a physical slot or receptacle.

The UE 100 may be configured to restrict use of the respective networks to certain applications or groups of applications. For example, a secure work or communication app (that is a member of a first group of apps 110) that accesses confidential data may be configured to only communicate with the private 5G network 140; whereas another app (that is a member of a second group of apps 130) may be configured to only communicate with the public 5G network 150. Such restrictions may be associated by the respective network, the respective app, or enforced by a third party (such as a business or organization). Applications themselves may be subject to additional security requirements. For instance, the installation and execution of a particular app (e.g., from a trusted source) may be limited to a particular device (e.g., with trusted hardware) and subjected to specific security settings. The techniques discussed herein enable further network restrictions where only a particular type, class, group, or identity of an app can obtain network connectivity on a private network. Among other use cases, this enables automatic bindings of particular apps to private network connectivity settings.

The UE 100 may include a number of identifiers 120 tied to the network, device, or app, which are used to authenticate and establish identity. These include identifiers such as a universal unique identifier (UUID), unique device identifiers (UDID), subscriber identifier (SUPI), device identifier (MEI) network identifiers (SIM/UICC ID). Additionally, the approaches below introduce the use of a UIQFP that provides a random value used for authentication and secure connections.

FIG. 1B provides an expanded overview of the example connectivity setting with the user equipment. In this example, the UE 100 uses a first UICC and first UDID identifier value to establish connectivity of App 1 to the private 5G network 140; the UE 100 uses a second UICC and a third UDID identifier value to establish connectivity of App 3 to the public 5G network 150. Additionally, to authenticate the use of a particular app with the private 5G network 140, the UE 100 collects a set of unique values of IQ measurements from the respective networks, in the form of a first UIQFP 161, a second UIQFP 162, a third UIQFP 163, and a fourth UIQFP 164. The collection of a UIQFP is discussed in more detail below. The use of four measurements from UIQFPs is provided as an example, as fewer or more measurements may be used.

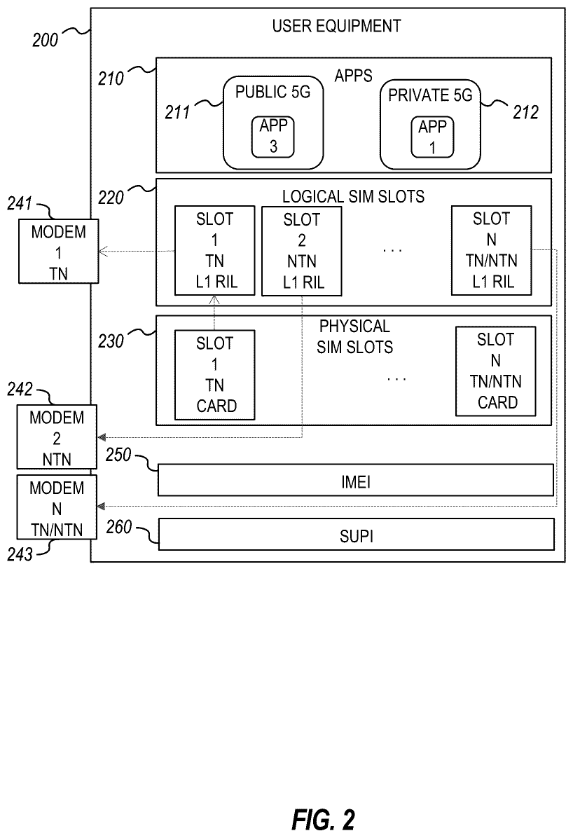

FIG. 2 depicts a modem configuration of a UE 200 (e.g., the same or similar to the UE 100) that is configured to communicate with private and public 5G networks. The UE 200 includes groups of apps, including a public 5G app group 211 and a public 5G app group 212. The UE 200 also includes SIM/eSIM slots defined for communication, provided by logical SIM slots 220 and physical SIM slots 230. The UE also includes device-specific identifiers such as a IMEI number 250 (International Mobile Equipment Identity number) and a SUPI number 260 (Subscription Permanent Identifier (SUPI) number).

For example, the logical SIM slots 220 may correspond to a series of eSIMs that are used to communicate with a terrestrial network (TN) or a non-terrestrial network (NTN), e.g., a low-earth orbit satellite network. The UE 200 may use slot 1 of the physical and logical SIM slots to communicate with a TN via modem 1 241, and use slot 2 of the logical SIM slots to communicate with an NTN via modem 2 242. A variety of other slot/network mappings may be provided, such as use of slot N of the logical SIM slots to communicate with a TN or NTN via modem N 243. The particular SIM/modem mapping may be used as an additional factor of authentication for access to a private 5G network, as discussed herein.

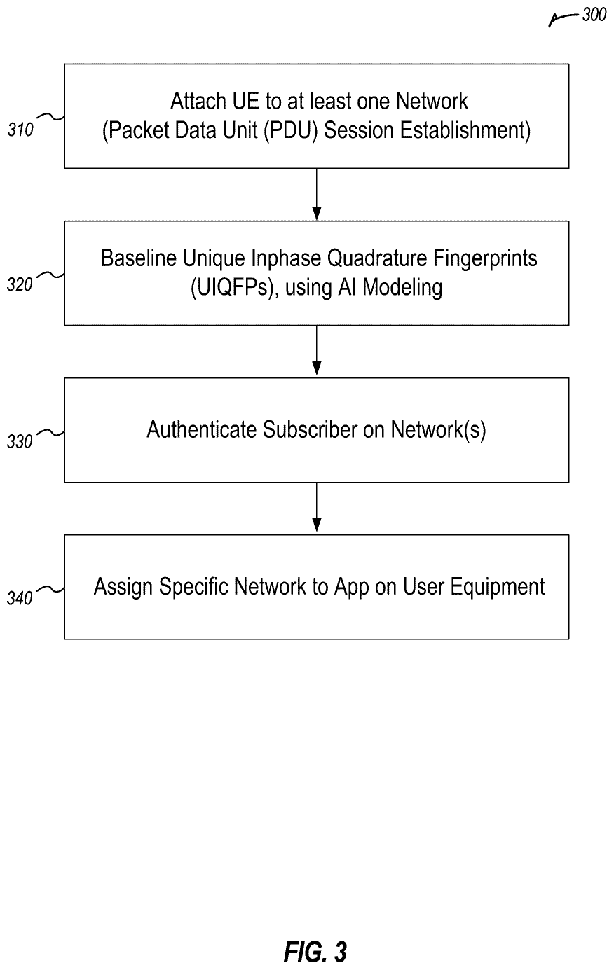

FIG. 3 depicts a flowchart of a data processing workflow for establishing connectivity of a user equipment and a user equipment application to a network. A “user equipment” and “device” are used interchangeably in the following sections. Although specific reference is provided to a 5G network, it will be understood that the techniques are equally applicable to other types of cellular data networks, including enhanced 5G and 6G configurations.

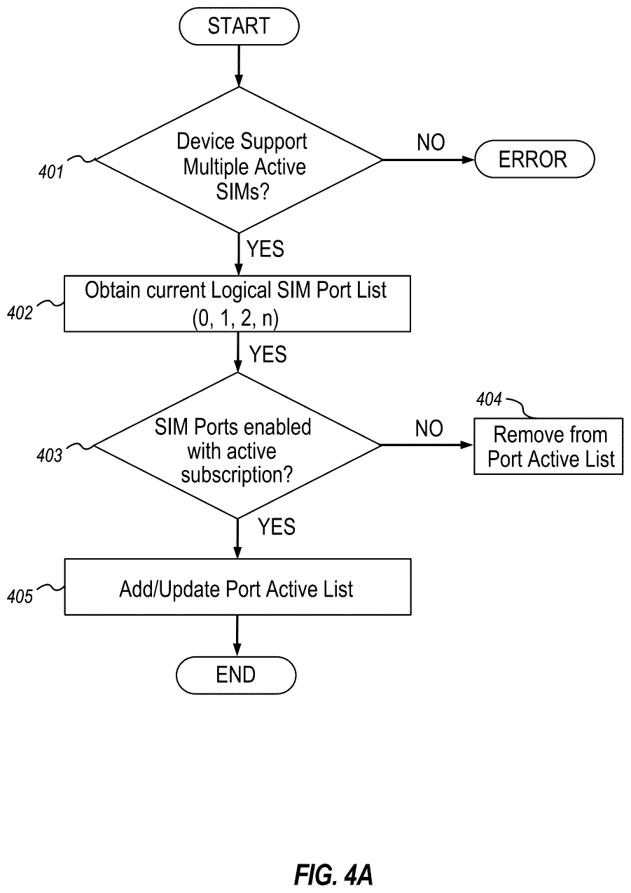

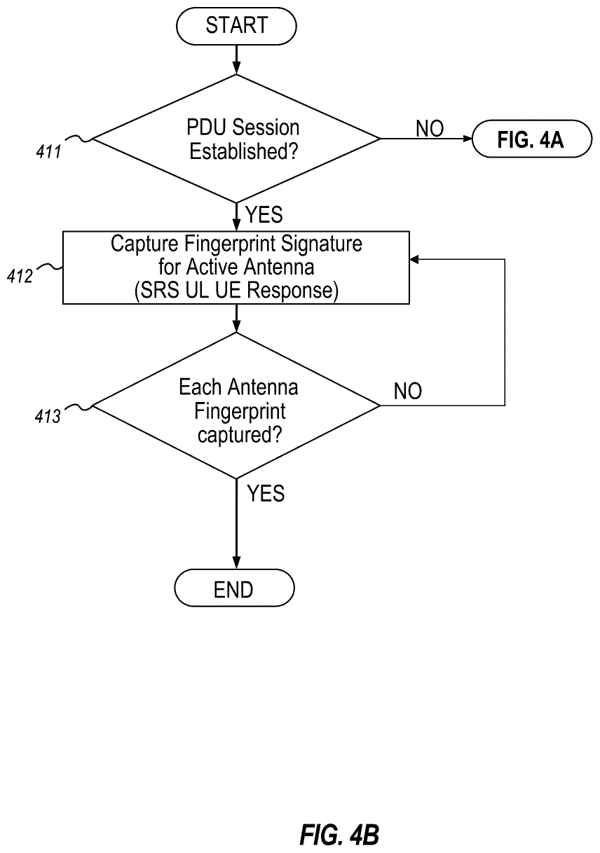

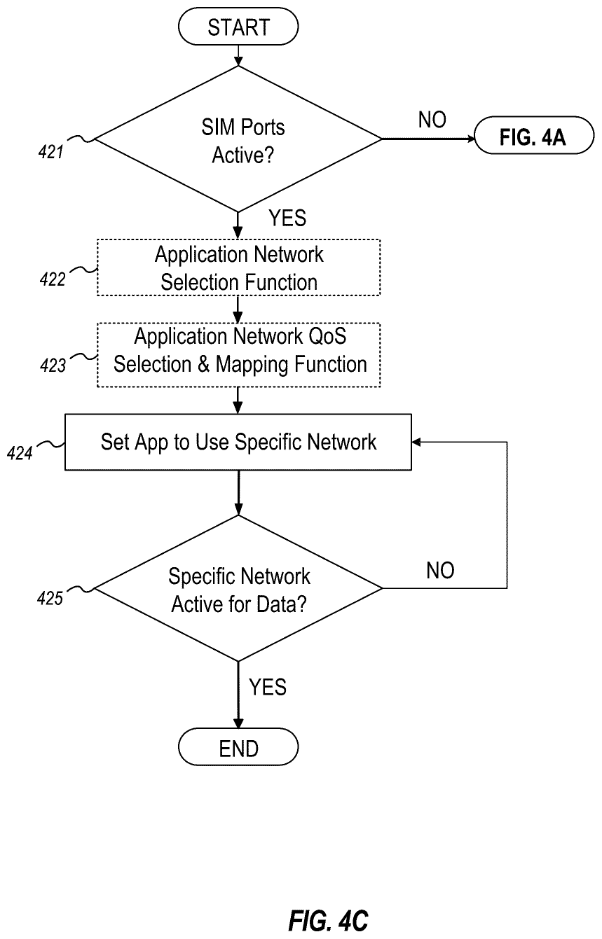

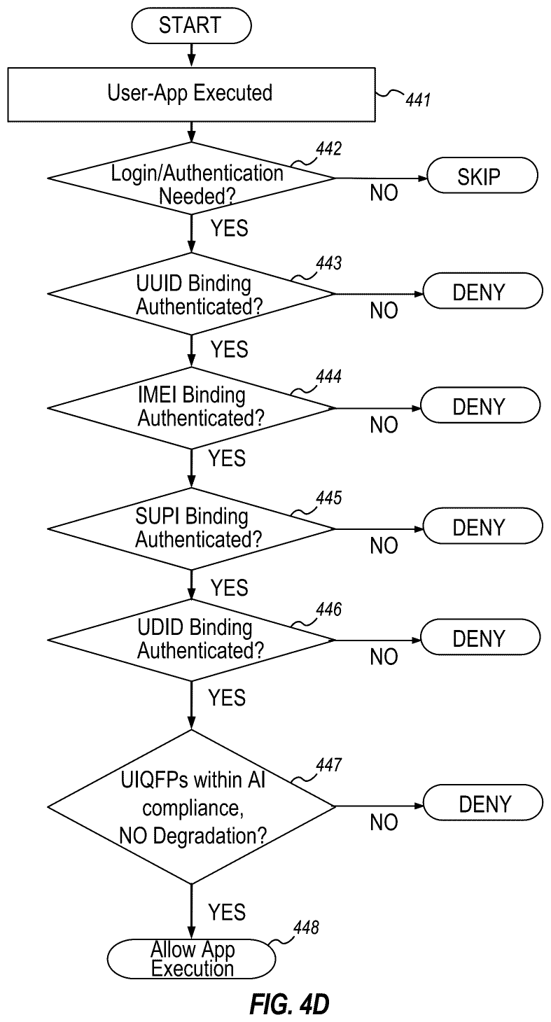

First, at operation 310, a UE is attached to at least one 5G network, including a private 5G network with enhanced authentication requirements. This attachment may include the use of a 5G PDU session establishment, which establishes a data path between the UE and the 5G core network. The attachment of the device to the network is described in more detail with FIG. 4A, below.

Next, at operation 320, the UE and private 5G network establish a baseline of IQ data “fingerprints” with the collection of UIQFP measurements. The baseline of the IQ fingerprints is described in more detail with FIG. 4B, below.

Next, at operation 330, a subscription associated with the UE is authenticated on the private 5G network, based on various identifiers associated with the UE. Additional details on network, device, and application authentication are described below.

Finally, at operation 340, a specific network is associated with (e.g., assigned to) the app on the UE. This app-to-network mapping is depicted in more detail with FIG. 4C, below.

In an example, the authentication at operation 330 is based on a combination of network binding, SIM binding, subscriber binding, device binding, and application binding. The network binding may occur on the basis of a UICC. The application binding may occur based on binding to a per-app UUID. The device binding may occur based on binding to a UDID. The subscriber binding may occur on the basis of a SUPI. The verification of this authentication process, for a particular app associated with a network is depicted in more detail with FIG. 4D, below.

FIG. 4A depicts a first aspect of setup for 5G network degradation monitoring, involving the attachment of a device to at least one network with a PDU session establishment. At determination 401, the device is verified to support multiple active SIMs. At operation 402, the current logical SIM port list (from 0 to n ports) is obtained. At determination 403, the device is verified to have SIM ports enabled with an active subscription. If this verification fails (e.g. the SIM ports are not enabled, or there is not an active subscription), then respective SIM ports are removed from the port active list at operation 404. If this verification succeeds (e.g., the SIM ports are enabled and have an active subscription), then respective SIM ports are added or updated in the port active list at operation 405.

FIG. 4B depicts a second aspect of setup for 5G network degradation monitoring, involving establishing the baseline of one or more UIQFPs. At determination 411, a verification is performed that the PDU session is established. If not yet established, then the attachment of the device is performed as in FIG. 4A. At operation 412, a fingerprint signature (a UIQFP) is captured for each active antenna. In an example, this fingerprint signature is based on IQ measurements of an uplink (UL) sounding reference signal (SRS) UE response. Other IQ measurements may be established from other messages and responses. At determination 413, a verification is performed to ensure that each antenna fingerprint is collected. Operation 412 is repeated if some of the antenna fingerprints are not captured.

FIG. 4C depicts a third aspect of 5G network degradation monitoring, involving configuration of a particular application on the device for use with a specific network. First, at determination 421, a verification is made whether the SIM ports are active. If the SIM ports are not active, then the attachment of the device is performed as in FIG. 4A. At operation 422, an optional application-network selection function is performed. This selection function may involve selecting or verifying a particular network based on the type or characteristic of the application. At operation 423, an optional application-network QoS selection and mapping function is performed. This selection function may involve selecting or verifying a particular network based on the QoS characteristics of the application and/or the network. At operation 424, the application is set to use a specific network (e.g., a private 5G network). At determination 425, a verification is performed that the specific network is active for data; if this verification fails, then operation 424 may be repeated to select another network.

In an example, the application network selection function (e.g., in optional operation 422) applies multiple selection rules. These selection rules can be set based on policies provided by external policy sources, such as: an emergency services policy controller (based on geographic area, region, location, or event); an MNO policy function controller; an application default configuration; an application back-end policy controller/distribution function; default rules based on governance provided by a handset or device vendor; or government security services.

Network selection may be based on particular use cases for apps or device services. The following demonstrates an example of selection function rules. As a first example, public emergency service applications (e.g., 911) and emergency dialing app voice services may register to only connect to Public 5G Network with emergency service availability, with the option to fallback to a Private 5G network if no Public 5G network is available. As a second example, a Private 5G Network can be selected for use with a specific device App based on a variety of factors such as: geo-location, signal strength, block error rate (BER), signal/noise (S/N) ratio, application back-end service cloud connectivity, access point name (APN) availability and battery level. As a third example, AI/ML predicted network connectivity and network/connection health can also be used to select a particular network for a particular app use case, when multiple networks are available. As a fourth example, public safety network access availability and services availability can be modeled independently on the UE and selected by the application based on a best available match.

Applications can select networks can based on network security features and/or based on a policy. The policy can specify required security features for the network selection such as: selection of ciphers for a VPN tunnel to back-end service, based on a security policy (e.g., available ciphers can be provided by the back-end application service based on IPSEC tunnel negotiations); selection from a list of trusted/untrusted DNS services; selection from a list of DNS servers with support for DNS Security Extensions (DNSSEC); selection from a list of trusted/untrusted APNs (Access Point Names)—for Public and Private networks; selection from a list of trusted mobile network operator (MNO) networks.

In further examples, the UE can build combined automatic selection models. Such models can be built or customized for each pair of network and applications, based on telemetry inputs for: Tracking areas; Availability of MNO networks; Availability of the application back-end services. Application backend services can also deploy such models or related policies at the RAN/Network Edge or as part of a distributed cloud. The selection models can be deployed to multiple UEs or networks, to be provided as part of an Application Network Selection Function to select the best matching network.

In an example, the Application Network QoS Selection and Mapping Function (e.g., in optional operation 423) may consider capabilities that map specific Apps to specific ports with QoS Capability. Such mapping may be policy configurable, and can be based on service capabilities relating to power, thermal, performance, availability, reliability and more. The QoS selection and mapping may allow dynamic re-mapping with telemetry and AI-driven heuristics (that is policy configurable). The QoS selection and mapping can allow bandwidth sharing and failover/fallback for Apps identified as critical (e.g., 911 emergency services/411 informational services/etc.), enabling an App to switch networks between one or many profiles (e.g. Private vs. Hybrid vs. Public) based on QoS availability and any failure(s) detected in the deployment.

FIG. 4D depicts a fourth aspect of verification of 5G network degradation monitoring, during execution of the application that attempts to use a private network. At operation 441, the app is executed on the user equipment and makes a request to use a private 5G network connection. This causes the following series of authentication operations.

The following authentication operations are performed in response to a determination 442 that a login or authentication is needed for the particular app. (If the login or authentication is not needed, then the following authentication operations are skipped). At determination 443, a UUID binding is authenticated. At determination 444, an IMEI binding is authenticated. At determination 445, a SUPI binding is authenticated. At determination 446, a UDID binding is authenticated. If any of these authentications fail, then execution of the application or use of the private 5G network connection is denied.

At determination 447, the UIQFPs are evaluated by an AI model to determine that the UIQFPs are compliant and have no degradation. If these values are not compliant, then then execution of the application or use of the private 5G network connection is denied. Details on capturing and evaluating the UIQFPs are discussed in more detail below. If the authentications succeed and the evaluation of the UIQFPs is determined as compliant, then the app execution is allowed in operation 448.

As an extension of these authentication techniques, a set of device pairs may be required for authentication of either device with the private 5G network. This may provide a robust authentication mechanism that requires two devices (from two different users) to gain access. This pair of devices could be related through the deployment of asymmetric keys to validate each other or using EPID, making it possible to verify group membership. This enables a similar use of dual-control safe/two-key safe in which, for specific scenarios, more than one user (in this case, the user's device) is needed to connect and perform any further activity on the network.

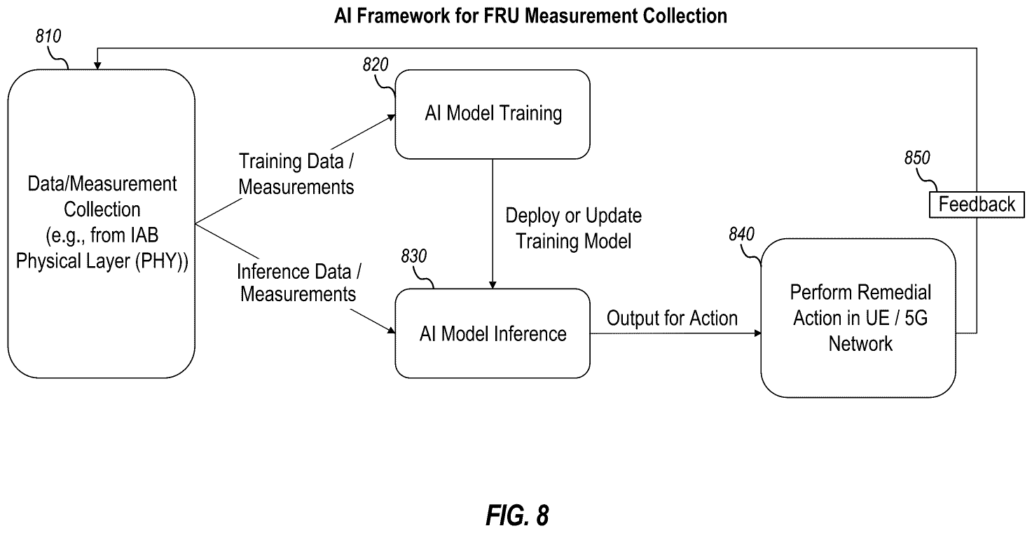

The following discusses the collection of UIQFPs, and the comparison and evaluation of this and other IQ data to determine whether network conditions have degraded as a result of interference, device malfunction or misconfiguration, or other unexpected service disruptions. The comparison and evaluation of IQ data can include the use of an algorithm or process to create, train, and operate an AI learning model to identify service disruption events or unexpected conditions, whether caused by interference, channel and multi-pass interference, or scheduling constraints. More details on a possible AI model implementation are provided with reference to FIG. 8 below.

As will be understood, in the 5G communications setting, IQ reference data (also known as “I/Q data”) generally refers to the components of an observed signal (the in-phase and quadrature phases of a sine wave), providing a representation of how a carrier is modulated in frequency, amplitude, and phase. The unique fingerprint of IQ reference data samples produced at a UE can be baselined and then compared against live periodic real-time monitoring of path loss situations (referred to herein as periodic fingerprint responses).

For instance, if a periodic fingerprint response (e.g., a value at time n) is greater than a baseline (e.g., an initial value at time 0) initial fingerprint response, then a network disruption scenario may be identified. The detection of the network disruption scenario may be used to trigger or control a remedial action, including to identify that an unsecure or compromised network condition has occurred. These scenarios may be further analyzed by AI inference or training models, and such AI inference or trained models may be used to recommend or automatically implement network changes that reduce or resolve the disruption, or which trigger the change to another network. The training of such models may be performed via supervised or unsupervised approaches, based on the collection of ongoing outcome or network operation data (as discussed in more detail with reference to FIG. 8, below).

These data processing operations may be used in a variety of scenarios to detect security breaches or compromised equipment, monitor for mis-configuration or mis-deployment of a network, or detect other improper or incorrect network configurations. As a non-limiting example, a security breach or attempts by a man-in-the-middle attack to intercept cellphone data can be easily detected from abnormal fingerprint data measurements, as compared with earlier fingerprint measurements captured at the UE. The adaptive nature of these techniques also enable minor remedial actions (e.g., reconfiguring one antenna, changing certain network settings, etc.) or major remedial actions (e.g., turning off one or more antennas, or shutting down a node), or recommending and enacting remedial actions that are determined in real-time.

Various processing techniques with AI models and algorithms may be used on a fingerprint dataset, including processing to classify, sort through, process, and act on fingerprint response information. Such fingerprint response information that is relevant to the identification of a network disruption scenario may include but is not limited to measurements in one or more of: Block Error Rate, or BLER (Number of erroneous blocks/the Total number of blocks received); SNR (signal-to-interference/noise ratio), RSRP (Reference Signal Received Power); and RSRQ (Reference Signal Received Quality). Any of these measurements can be used to trigger a remedial action, or to identify network degradation or an uncompliant state.

Predetermined thresholds can be manually recorded and/or AI-directed based on IQ signatures and recorded data values. The use of adaptive thresholds and Al analysis may be especially useful in temporary private 5G deployments where communication services may be essential, for example 5G applications that are temporarily placed in a particular area for critical communication services (e.g., government, entertainment, commercial use cases).

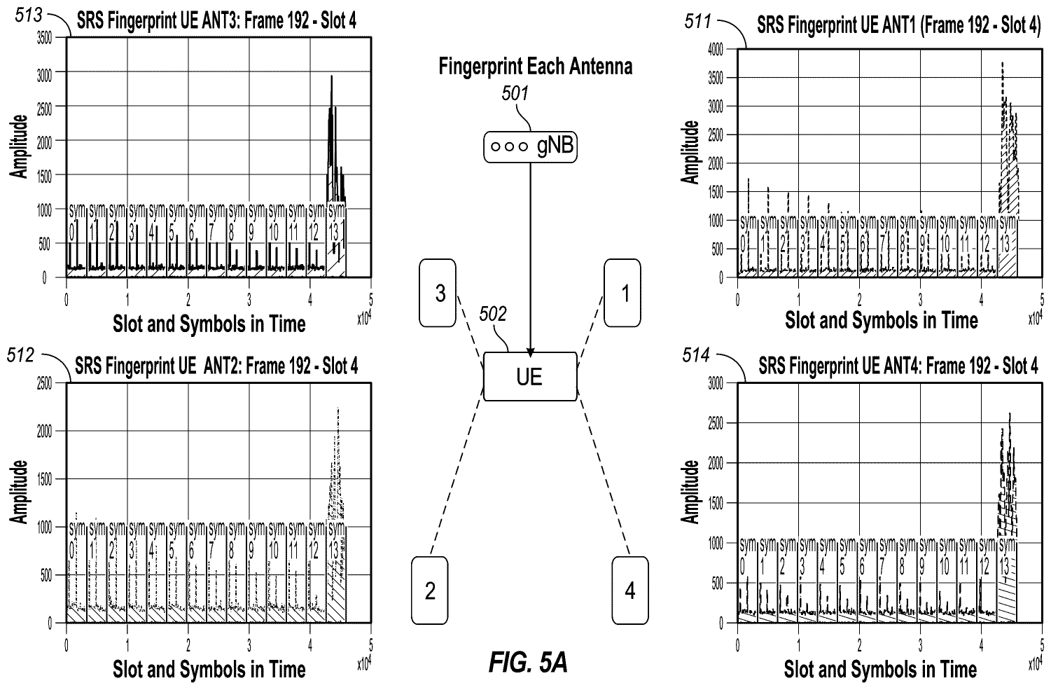

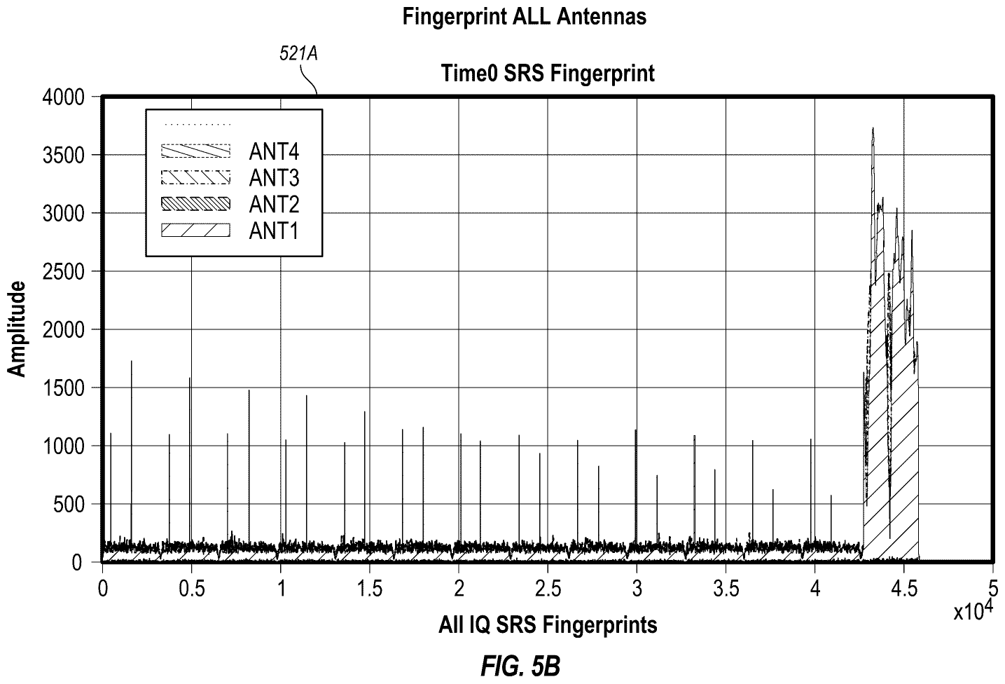

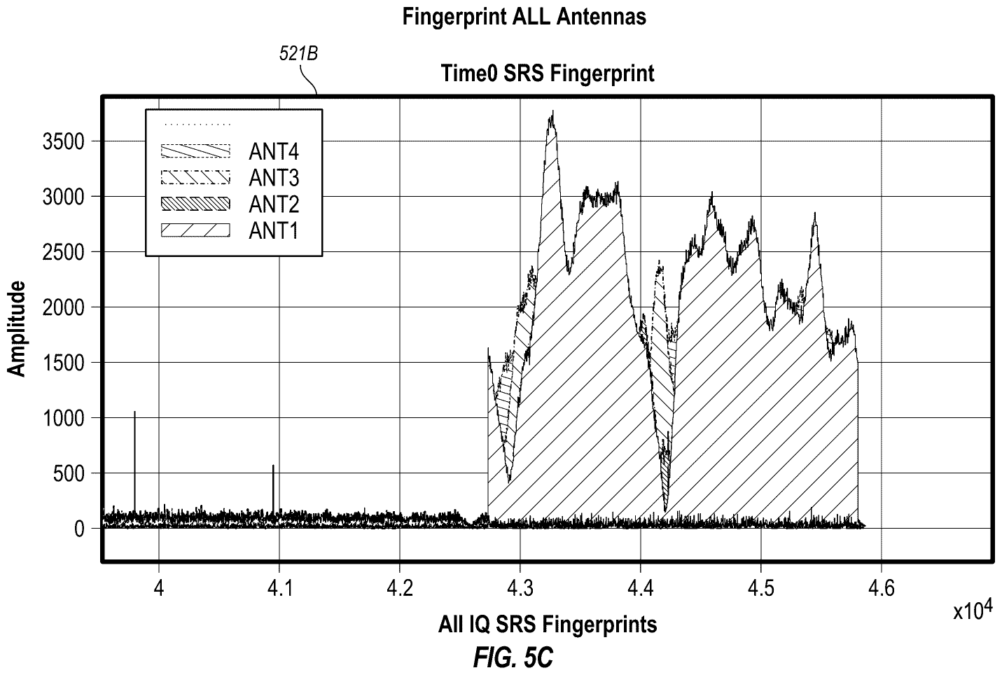

FIGS. 5A to 5C illustrate measurements from gNB configurations that operate an FRU device for network measurements. Here, these graphs visually show measurements of an SRS fingerprint that is provided with the individual antennas (in FIG. 5A) or collectively with four antennas (in FIG. 5B).

In FIG. 5A, separate data graphs 511, 512, 513, 514 respectively depict SRS fingerprint measurements, provided from a UE 502, captured over time from antennas 1, 2, 3, 4 of a gNB 501. The SRS fingerprint measurements at the gNB 501 measure an amplitude of the signal, relative to slots and symbols over time. In FIG. 5B, a single data graph 521A provides an overlay of data that combines the data of the four antennas into a single fingerprint. FIG. 5C provides a more detailed view of the fingerprint based on the combined data from the four antennas in graph 521B.

Accordingly, the variability of the SRS measurements and the resulting UIQFP demonstrate how IQ fingerprinting can be used as part of an authentication method, especially for Apps that are associated with a Private 5G Network. A UIQFP also can be used to provide guardrails that are Private 5G site specific, especially in private 5G settings and implementations where randomness in an authentication method is critical in determining access.

Randomness for the authentication method can be derived from the signatures of the UIQFPs, which can be implemented on an SRS response or by extracting/deriving information from actual IQ data measurements (e.g., as indicated in operation 320 in FIG. 3). The randomness is based on the IQ data (complex numbers) of communications within that network so AI-enabled guardrails, including allow/do-not-allow verifications, can be implemented.

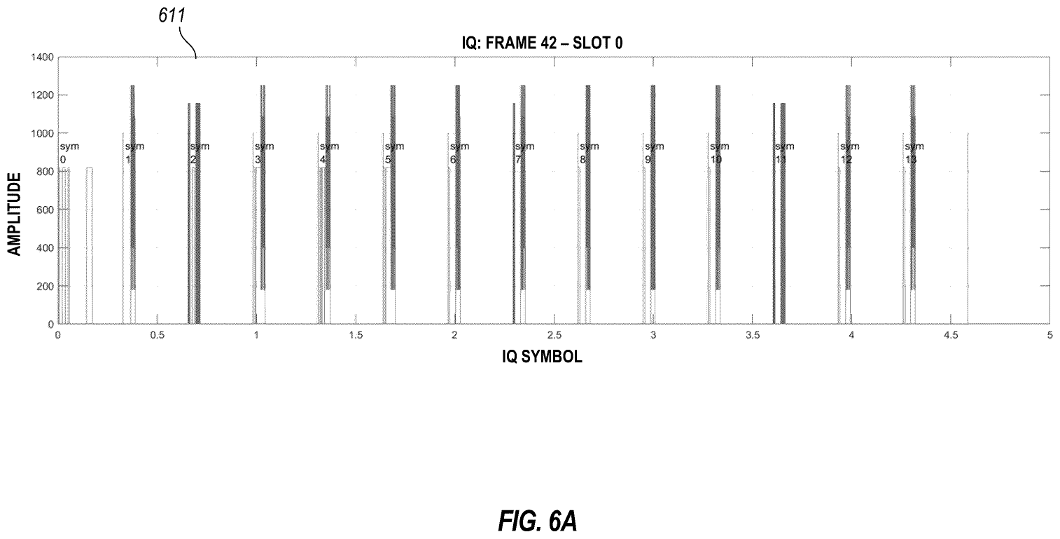

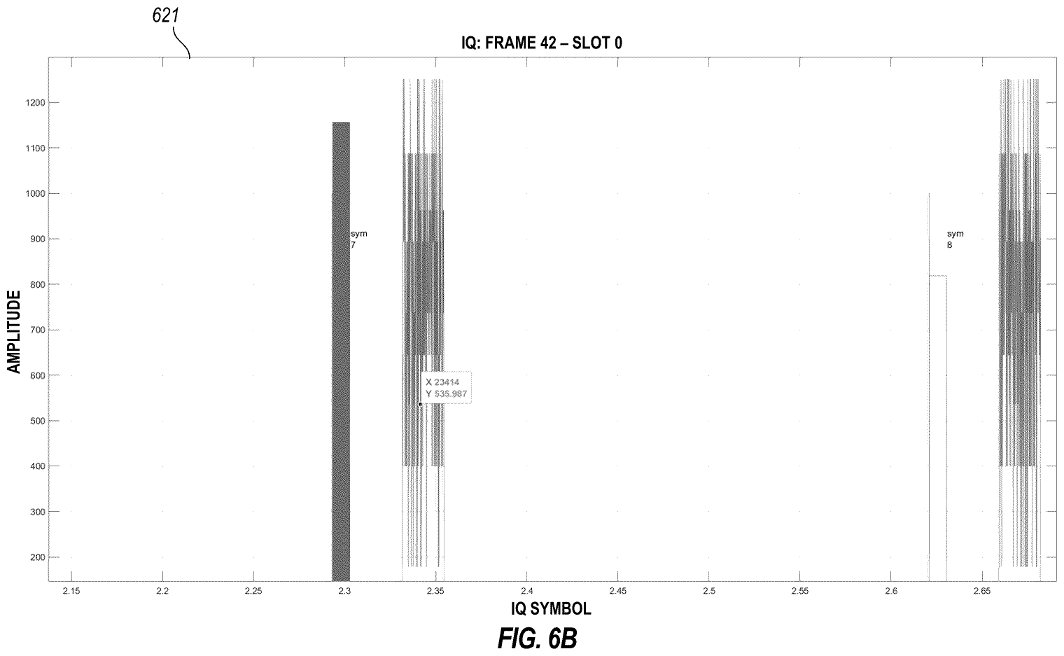

FIG. 6A depicts an example graphical representation of an IQ symbol measurement 611, in a particular frame and slot. This representation demonstrates randomness in signal amplitude even when looking at the data IQs samples for one DL frame, one slot 7, and a few symbols. FIG. 6B depicts a closeup graphical representation of an IQ symbol measurement 621, showing a comparison of two particular symbols (symbol 7 and 8) to the actual captured data.

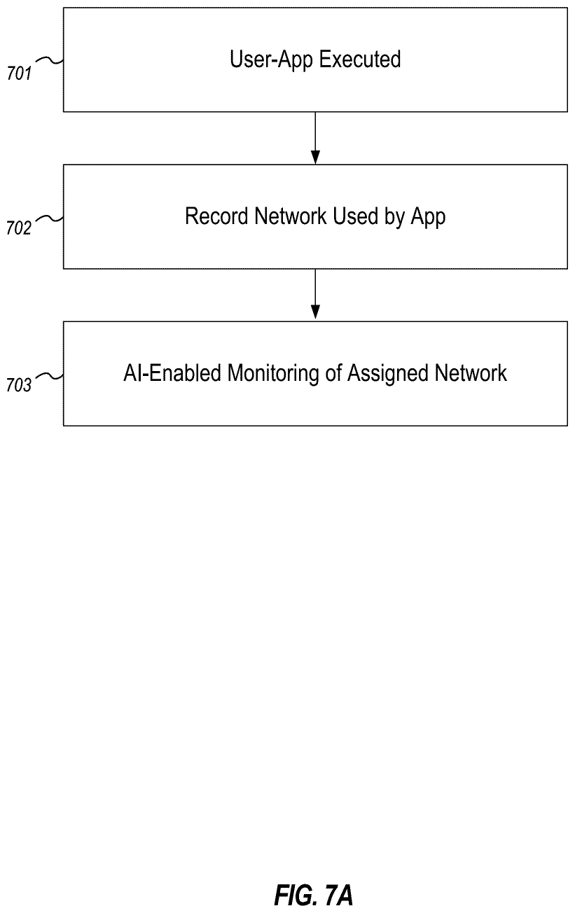

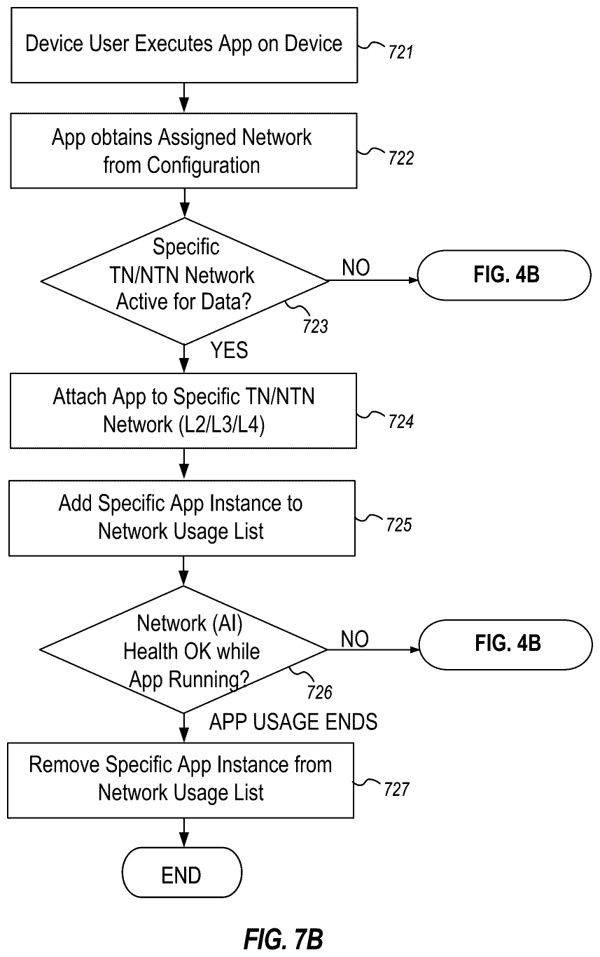

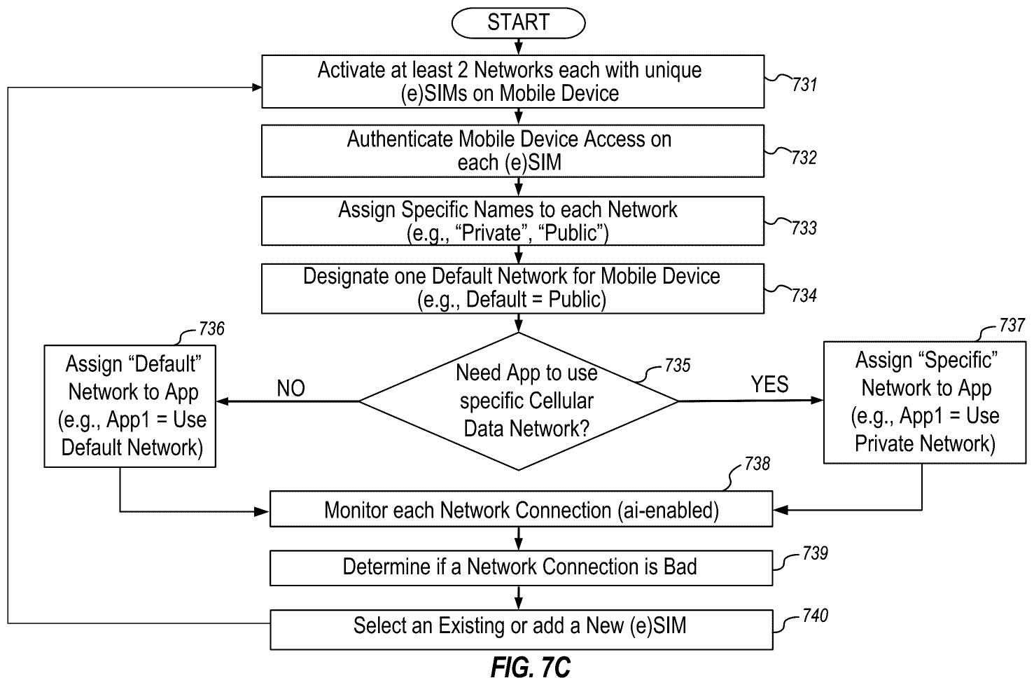

FIG. 7A depicts a flowchart of example operations for monitoring use of a user App on a UE, connected to a particular network (e.g., a private 5G network). These operations may be enabled after enabling an app execution and use with the particular network, such as based on the flow of FIG. 4D.

At operation 701, the user-app is executed. At operation 702, the network used by the app (and assigned to the app) is recorded or logged. At operation 703, an AI-enabled monitoring of the assigned network is provided, to ensure secure operations. An expanded view of operations 701, 702, and 703 are provided in the following scenarios in FIGS. 7B and 7C.

FIG. 7B depicts a flowchart of operations to maintain connectivity of a user App on a UE, connected to a particular network. At operation 721, a device user executes a specific App on the device. At operation 722, the specific App obtains the assigned network from a configuration (or based on a policy or condition, as discussed above).

An evaluation is made at determination 723 whether the assigned TN/NTN network is active for data connections from the specific App. If the specific TN/NTN network is not active, then operations of FIG. 4B may be performed to establish a session and baseline fingerprint measurements. If the specific TN/NTN network is active, then the app may be attached to the specific TN/NTN network in operation 724, and the specific app instance can be added to a network usage list in operation 725.

An evaluation is performed at determination 726 to verify that the network health remains acceptable while the app is running and using the network (e.g., using the private 5G network). If the network health is deficient or outside of defined/determined ranges of normal health (e.g., based on rules or analysis by an AI model), then the operations of FIG. 4B can be used to re-initialize the network connection and establish a new baseline. If the network health is acceptable and within defined/determined ranges of normal health, then, then the health check is repeated until the use of the application ends. Once the use of the application ends, the specific app instance is removed from the network usage list at operation 727.

FIG. 7C depicts a detailed flowchart for the use of multiple applications among multiple networks, labeled here as a “Private” network and as a “Public” network. The flowchart expands the operations described with FIG. 7B, and shows how network connection monitoring may be applied for multiple 5G networks.

At operation 731, at least two networks are activated on the mobile device, using unique SIM/eSIM slots. The mobile device access is authenticated with each SIM/eSIM at operation 732. The mobile device also assigns specific names or identifiers to each network at operation 733, such as to identify a non-terrestrial 5G network as a “Private” network, and to identify a terrestrial 5G network on a public (subscription-based) wireless carrier as a “Public” network. The mobile device designates one of the networks as a default network for connectivity at operation 734.

An evaluation is performed when a specific App is used at determination 735, to evaluate whether the specific App is required to use a specific cellular data network. If the specific App is not required to use a specific cellular data network, then the default network is assigned to the specific App at operation 736. If the specific App is required to use a specific network, then this specific network (e.g., the “Private” network) is assigned to the specific App at operation 737.

The remaining operations include monitoring each network connection for degradation and interruption at operation 738, and determining whether a network connection is degraded (bad) to prevent connectivity at operation 739. If the network connection does not provide connectivity, then an existing or new SIM/eSIM are selected at operation 740, followed by repeated operations 731-738.

FIG. 8 depicts a flowchart of an example AI training and inference framework for IQ fingerprint measurement collection. Here, this flowchart shows how physical layer (PHY) data and measurements are collected for use in training and inference scenarios, for any of the AI model use cases referenced herein. Other sources of data and measurements may be added to training and inference operations.

Specifically, FIG. 8 depicts aspects of the collection of data and measurements used for training and learning/inferencing operations within a functional framework. First, operation 810 shows a Data/Measurement collection (e.g., from the 5G network physical layer (PHY)), with these data/measurements to provide input data for training operations 820 and inference operations 830.

This input data may include but is not limited to gNB PHY and UE data and measurements (such as channel state information, or responses from reference signals such as RSRQ and RSRP) within the currently used channels. Measurements from Physical layers can include 5G NR uplink Fingerprint Reference Signal (FRS) Responses or any other reference signals that could be used to derive measurements and detect the channel state information. Thus, measurements may also include or be based on power and/or amplitude-related responses (e.g., to detect signal strength and anomalies associated with over-the-air transmission).

These and similar measurements can be used as inputs to an AI Model (for training operations 820 or inference operations 830), or to trigger automated alerts and actions that cause adjustments in the UE network selection or configuration (such as at operation 840). Feedback 850 that is collected from the performed action may also provide additional data measurements for additional training and inference.

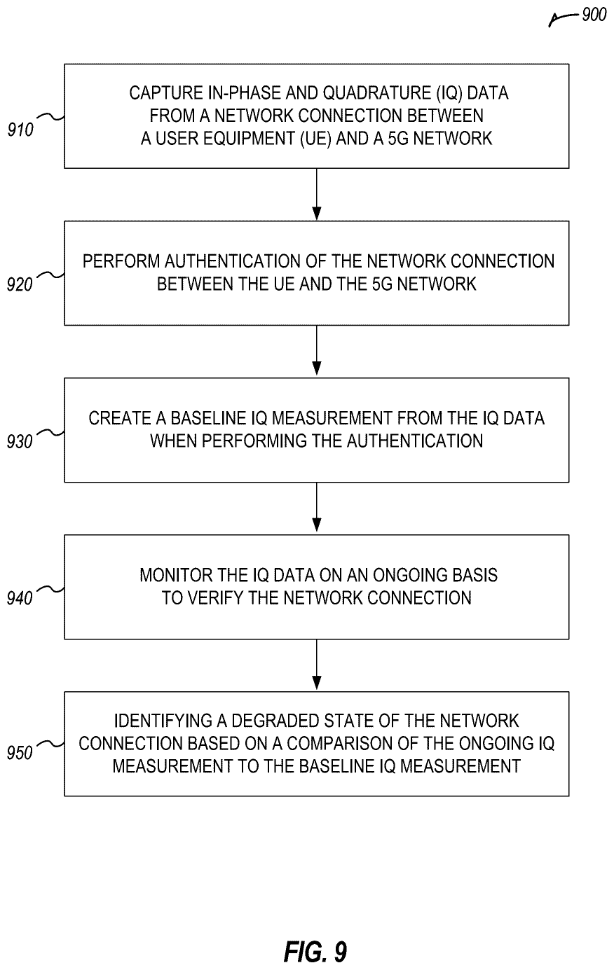

FIG. 9 depicts a flowchart 900 of an example method of using fingerprint measurements for authentication of network use based on IQ data, with the techniques discussed above. IQ data provides random (and not pseudo random) data which can be used as a source of randomness to assist the authentication of the UE. This IQ data may be collected and then continuously monitored, to help verify the network connection or a state of authentication of the UE.

Operation 910 includes capturing in-phase and quadrature (IQ) data from a network connection between a user equipment (UE) and a 5G network. This IQ data may be captured based on communications between the UE and a 5G Network RAN/gNB Antenna(s). In specific examples the IQ data includes measurements captured from a reference signal transmitted between at least one antenna of the UE and at least one serving cell antenna of the 5G network, and the reference signal is an uplink sounding reference signal (SRS) or a downlink channel state information reference signal (CSI-RS).

Operation 920 includes performing authentication of the network connection between the UE and the 5G network, such as by using a symbol of the IQ data as a random factor for the authentication. This authentication of the network connection may be performed in response to a packet data unit (PDU) session establishment between the UE and the 5G network. In scenarios where the operations of flowchart 900 are performed by the UE, the authentication of the network connection between the UE and the 5G network can be further based on at least one identifier associated with the 5G network or the UE.

Operation 930 includes creating a baseline IQ measurement from the IQ data when performing the authentication between the UE and the 5G network. Examples of creating and establishing a baseline are provided in FIGS. 5A to 5C, discussed above.

Operation 940 includes monitoring the IQ data on an ongoing basis to verify the network connection between the UE and the 5G network. This monitoring of the IQ data may include (or be based on) a comparison of an ongoing IQ measurement to the baseline IQ measurement.

Operation 950 includes identifying a degraded state of the network connection based on a comparison of the ongoing IQ measurement to the baseline IQ measurement, such as when the difference between the measurements is outside a determined range. In an example, this determined range is identified based on use of a trained model (e.g. an AI model such as a neural network, or a model incorporating AI-based techniques).

Additional operations (not depicted in FIG. 9) may include assigning an application installed on the UE for exclusive connectivity with a specific 5G network such as a private 5G network, based on the authentication of the network connection between the UE and the 5G network and the at least one identifier associated with the 5G network or the UE. Thus, the ongoing monitoring of the IQ data (as in operation 940) may be a prerequisite or pre-condition for use of the private 5G network. In such scenarios, the user equipment can be capable of performing communications with a public 5G network and the private 5G network using respective SIM slots, and the use (or switching/selection/assignment) of the public 5G network or the private 5G network is based on an application network selection function, a Quality of Service (QOS) selection and mapping function, a security requirement, or some combination thereof.

Additional examples of the presently described method, system, and

device embodiments include the following, non-limiting implementations. Each of the following non-limiting examples may stand on its own or may be combined in any permutation or combination with any one or more of the other examples provided below or throughout the present disclosure.

Example 1 is a method of using fingerprint measurements for authentication of network use, the method comprising: capturing in-phase and quadrature (IQ) data from a network connection between a user equipment (UE) and a cellular data network (e.g., a 5G network); performing authentication of the network connection between the UE and the 5G network, using the IQ data; and monitoring the IQ data on an ongoing basis to verify the network connection between the UE and the 5G network.

In Example 2, the subject matter of Example 1 optionally includes subject matter where the 5G network is a private 5G network, wherein the user equipment is capable of performing communications with a public 5G network and the private 5G network using respective SIM units or slots, and wherein the use of the public 5G network or the private 5G network is based on an application network selection function, a Quality of Service (QOS) selection and mapping function, or a security requirement.

In Example 3, the subject matter of Example 1 optionally includes creating a baseline IQ measurement from the IQ data when performing the authentication between the UE and the 5G network; wherein monitoring the IQ data includes a comparison of an ongoing IQ measurement to the baseline IQ measurement.

In Example 4, the subject matter of Example 3 optionally includes identifying a degraded state of the network connection when the comparison of the ongoing IQ measurement to the baseline IQ measurement is outside a determined range.

In Example 5, the subject matter of Example 4 optionally includes subject matter where the determined range is identified based on use of a trained model.

In Example 6, the subject matter of any one or more of Examples 1-5 optionally include subject matter where the authentication of the network connection is performed based on using a symbol of the IQ data as a random factor for the authentication.

In Example 7, the subject matter of any one or more of Examples 1-6 optionally include subject matter where the authentication of the network connection is performed in response to a packet data unit (PDU) session establishment between the UE and the 5G network.

In Example 8, the subject matter of any one or more of Examples 1-7 optionally include subject matter where the in-phase and quadrature (IQ) data includes measurements captured from a reference signal transmitted between at least one antenna of the UE and at least one serving cell antenna of the 5G network, and wherein the reference signal is an uplink sounding reference signal (SRS) or a downlink channel state information reference signal (CSI-RS).

In Example 9, the subject matter of any one or more of Examples 1-8 optionally include subject matter where the method is performed by the UE, and wherein the authentication of the network connection between the UE and the 5G network is further based on at least one identifier associated with the 5G network or the UE.

In Example 10, the subject matter of Example 9 optionally includes assigning an application installed on the UE for exclusive connectivity with the 5G network, based on the authentication of the network connection between the UE and the 5G network and the at least one identifier associated with the 5G network or the UE.

Example 11 is a device, comprising: processing circuitry; and a memory device including instructions embodied thereon, wherein the instructions, when executed by the processing circuitry, configure the processing circuitry to perform operations that: obtain in-phase and quadrature (IQ) data from a network connection between a user equipment (UE) and a cellular data network (e.g. a 5G network; perform authentication of the network connection between the UE and the 5G network, using the IQ data; and monitor the IQ data on an ongoing basis to verify the network connection between the UE and the 5G network.

In Example 12, the subject matter of Example 18 optionally includes subject matter where the 5G network is a private 5G network, wherein the user equipment is capable of performing communications with a public 5G network and the private 5G network using respective SIM units or slots, and wherein the use of the public 5G network or the private 5G network is based on: an application network selection function, a Quality of Service (QOS) selection and mapping function, or a security requirement

In Example 13, the subject matter of Example 12 optionally includes subject matter where the instructions further configure the processing circuitry to perform operations that: create a baseline IQ measurement from the IQ data when performing the authentication between the UE and the 5G network; wherein monitoring of the IQ data includes a comparison of an ongoing IQ measurement to the baseline IQ measurement.

In Example 14, the subject matter of Example 13 optionally includes subject matter where the instructions further configure the processing circuitry to perform operations that: identify a degraded state of the network connection when the comparison of the ongoing IQ measurement to the baseline IQ measurement is outside a determined range.

In Example 15, the subject matter of Example 14 optionally includes subject matter where the determined range is identified based on use of a trained model.

In Example 16, the subject matter of any one or more of Examples 11-15 optionally include subject matter where the authentication of the network connection is performed based on using a symbol of the IQ data as a random factor for the authentication.

In Example 17, the subject matter of any one or more of Examples 11-16 optionally include subject matter where the authentication of the network connection is performed in response to a packet data unit (PDU) session establishment between the UE and the 5G network.

In Example 18, the subject matter of any one or more of Examples 16-17 optionally include subject matter where the in-phase and quadrature (IQ) data includes measurements captured from a reference signal transmitted between at least one antenna of the UE and at least one serving cell antenna of the 5G network, and wherein the reference signal is an uplink sounding reference signal (SRS) or a downlink channel state information reference signal (CSI-RS).

In Example 19, wherein the operations are performed by the UE, and wherein the authentication of the network connection between the UE and the 5G network is further based on at least one identifier associated with the 5G network or the UE.

In Example 20, the subject matter of Example 18 optionally includes subject matter where the instructions further configure the processing circuitry to perform operations that: assign an application installed on the UE for exclusive connectivity with the 5G network, based on the authentication of the network connection between the UE and the 5G network and the at least one identifier associated with the 5G network or the UE.

Example 21 is a device, comprising: processing circuitry; and a memory device including instructions embodied thereon, wherein the instructions, when executed by the processing circuitry, configure the processing circuitry to perform operations for using fingerprint measurements for authentication of network use in accordance with Examples 1-20 or the techniques discussed herein.

Example 22 is a method, comprising a plurality of operations executed with a processor and memory of a device, to perform operations for using fingerprint measurements for authentication of network use in accordance with Examples 1-20 or the techniques discussed herein.

Example 23 is a machine-or device-readable storage medium including instructions, wherein the instructions, when executed by a processing circuitry of a machine or a device, cause the processing circuitry to perform operations for using fingerprint measurements for authentication of network use in accordance with Examples 1-20 or the techniques discussed herein.

Example 24 is an apparatus, comprising respective means for using fingerprint measurements for authentication of network use in accordance with Examples 1-20 or the techniques discussed herein.

Example 25 is a 5G communication network, comprising network equipment configured for using fingerprint measurements for authentication of network use, in a 5G network in accordance with Examples 1-20 or the techniques discussed herein.

Example 26 is a Radio Access Network (RAN) device, comprising computing hardware executing instructions for enabling or using fingerprint measurements for authentication of network use in accordance with Examples 1-20 or the techniques discussed herein.

Example 27 is a network comprising respective devices and device communication mediums for performing any of the operations or techniques discussed herein.

Example 28 is specially programmed circuitry configured to perform any of the operations or techniques discussed herein.

Example 29 is a system comprising respective components arranged or configured to perform any of the operations or techniques discussed herein.

Example 30 is a method, performed using circuitry of a computing device, arranged or configured to perform any of the operations or techniques discussed herein.

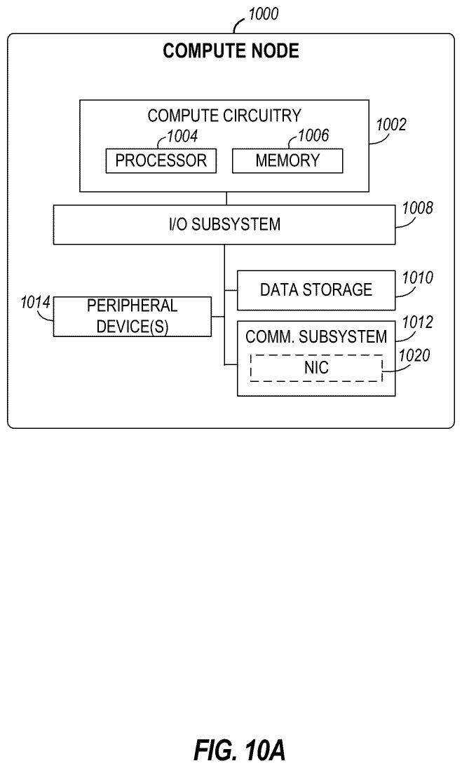

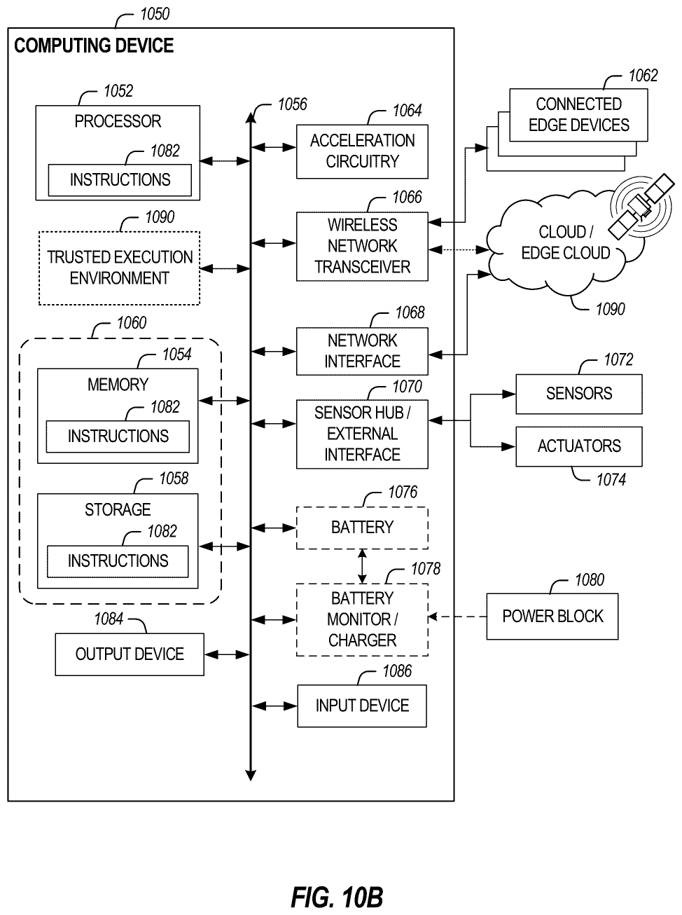

In further examples, any of the compute nodes or devices discussed with reference to the present computing systems and environment may be fulfilled based on the components depicted in FIGS. 10A and 10B. A compute node may be embodied as a type of device, appliance, computer, or other “thing” capable of communicating with other edge, networking, or endpoint components.

In the simplified example depicted in FIG. 10A, an edge compute node 1000 includes a compute engine (also referred to herein as “compute circuitry”) 1002, an input/output (I/O) subsystem 1008, data storage device 1010, a communication circuitry 1012 subsystem, and, optionally, one or more peripheral devices 1014. In other examples, a compute device may include other or additional components, such as those used in personal or server computing systems (e.g., a display, peripheral devices, etc.). Additionally, in some examples, one or more of the illustrative components may be incorporated in, or otherwise form a portion of, another component.

The compute node 1000 may be embodied as any type of engine, device, or collection of devices capable of performing various compute functions. In some examples, the compute node 1000 may be embodied as a single device such as an integrated circuit, an embedded system, a field-programmable gate array (FPGA), a system-on-a-chip (SOC), or other integrated system or device. In the illustrative example, the compute node 1000 includes or is embodied as a processor 1004 and a memory 1006. The processor 1004 may be embodied as any type of processor capable of performing the functions described herein (e.g., executing an application). For example, the processor 1004 may be embodied as a multi-core processor(s), a microcontroller, or other processor or processing/controlling circuit. In some examples, the processor 1004 may be embodied as, include, or be coupled to an FPGA, an application specific integrated circuit (ASIC), reconfigurable hardware or hardware circuitry, or other specialized hardware to facilitate performance of the functions described herein.

The main memory 1006 may be embodied as any type of volatile (e.g., dynamic random access memory (DRAM), etc.) or non-volatile memory or data storage capable of performing the functions described herein. Volatile memory may be a storage medium that uses power to maintain the state of data stored by the medium. Non-limiting examples of volatile memory may include various types of random access memory (RAM), such as DRAM or static random access memory (SRAM). One particular type of DRAM that may be used in a memory module is synchronous dynamic random access memory (SDRAM).

In one example, the memory device is a block addressable memory device, such as those based on NAND or NOR technologies. A memory device may also include a three-dimensional crosspoint memory device (e.g., Intel 3D Xpoint™ memory, other storage class memory), or other byte addressable write-in-place nonvolatile memory devices. The memory device may refer to the die itself and/or to a packaged memory product. In some examples, 3D crosspoint memory (e.g., Intel 3D Xpoint™ memory) may comprise a transistor-less stackable cross point architecture in which memory cells sit at the intersection of word lines and bit lines and are individually addressable and in which bit storage is based on a change in bulk resistance. In some examples, all or a portion of the main memory 1006 may be integrated into the processor 1004. The main memory 1006 may store various software and data used during operation such as one or more applications, data operated on by the application(s), libraries, and drivers.

The compute circuitry 1002 is communicatively coupled to other components of the compute node 1000 via the I/O subsystem 1008, which may be embodied as circuitry and/or components to facilitate input/output operations with the compute circuitry 1002 (e.g., with the processor 1004 and/or the main memory 1006) and other components of the compute circuitry 1002. For example, the I/O subsystem 1008 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some examples, the I/O subsystem 1008 may form a portion of a system-on-a-chip (SoC) and be incorporated, along with one or more of the processor 1004, the main memory 1006, and other components of the compute circuitry 1002, into the compute circuitry 1002.

The one or more illustrative data storage device 1010 may be embodied as any type of devices configured for short-term or long-term storage of data such as, for example, memory devices and circuits, memory cards, hard disk drives, solid-state drives, or other data storage devices. A data storage device 1010 may include a system partition that stores data and firmware code for the data storage device 1010. A data storage device 1010 may also include one or more operating system partitions that store data files and executables for operating systems depending on, for example, the type of compute node 1000.

The communication circuitry 1012 may be embodied as any communication circuit, device, or collection thereof, capable of enabling communications over a network between the compute circuitry 1002 and another compute device. The communication circuitry 1012 may be configured to use any one or more communication technology (e.g., wired or wireless communications) and associated protocols (e.g., a cellular networking protocol such a 3GPP 4G or 5G standard, a wireless local area network protocol such as IEEE 802.11/Wi-Fi®, a wireless wide area network protocol, Ethernet, Bluetooth®, etc.) to effect such communication.

The illustrative communication circuitry 1012 includes a network interface controller (NIC) 1020, which may also be referred to as a host fabric interface (HFI). The NIC 1020 may be embodied as one or more add-in-boards, daughter cards, network interface cards, controller chips, chipsets, or other devices that may be used by the compute node 1000 to connect with another compute device. In some examples, the NIC 1020 may be embodied as part of a system-on-a-chip (SoC) that includes one or more processors, or included on a multichip package that also contains one or more processors. In some examples, the NIC 1020 may include a local processor (not shown) and/or a local memory (not shown) that are both local to the NIC 1020. In such examples, the local processor of the NIC 1020 may be capable of performing one or more of the functions of the compute circuitry 1002 described herein. Additionally or alternatively, in such examples, the local memory of the NIC 1020 may be integrated into one or more components of the client compute node at the board level, socket level, chip level, and/or other levels.

Additionally, in some examples, a compute node 1000 may include one or more peripheral devices 1014. Such peripheral devices 1014 may include any type of peripheral device found in a compute device or server such as audio input devices, a display, other input/output devices, interface devices, and/or other peripheral devices, depending on the particular type of the compute node 1000. In further examples, the compute node 1000 may be embodied by a respective edge compute node in an edge computing system, or like forms of appliances, computers, subsystems, circuitry, or other components.

In a more detailed example, FIG. 10B illustrates a block diagram of an example of components that may be present in an edge computing node 1050 for implementing the techniques (e.g., operations, processes, methods, and methodologies) described herein. The edge computing node 1050 may include any combinations of the components referenced above, and it may include any device usable with an edge communication network or a combination of such networks. The components may be implemented as ICs, portions thereof, discrete electronic devices, or other modules, logic, hardware, software, firmware, or a combination thereof adapted in the edge computing node 1050, or as components otherwise incorporated within a chassis of a larger system. Further, to support the security examples provided herein, a hardware ROT (e.g., provided according to a DICE architecture) may be implemented in an IP block of the edge computing node 1050 such that any IP Block may boot into a mode where a RoT identity may be generated that may attest its identity and its current booted firmware to another IP Block or to an external entity.

The edge computing node 1050 may include processing circuitry in the form of a processor 1052, which may be a microprocessor, a multi-core processor, a multithreaded processor, an ultra-low voltage processor, an embedded processor, or other known processing elements. The processor 1052 may be a part of a system on a chip (SoC) in which the processor 1052 and other components are formed into a single integrated circuit, or a single package, such as the Edison™ or Galileo™ SoC boards from Intel Corporation, Santa Clara, California. As an example, the processor 1052 may include an Intel® Architecture Core™ based processor, such as a Quark™, an Atom™, a Xeon™, an i3, an i5, an i7, an i9, or an MCU-class processor, or another such processor available from Intel®. However, any number other processors may be used, such as available from Advanced Micro Devices, Inc. (AMD) of Sunnyvale, California, a MIPS-based design from MIPS Technologies, Inc. of Sunnyvale, California, an ARM-based design licensed from ARM Holdings, Ltd. Or a customer thereof, or their licensees or adopters. The processors may include units such as an A5-A13 processor from Apple® Inc., a Snapdragon™ processor from Qualcomm® Technologies, Inc., or an OMAP™ processor from Texas Instruments, Inc.

The processor 1052 may communicate with a system memory 1054 over an interconnect 1056 (e.g., a bus). Any number of memory devices may be used to provide for a given amount of system memory. As examples, the memory may be random access memory (RAM) in accordance with a Joint Electron Devices Engineering Council (JEDEC) design such as the DDR or mobile DDR standards (e.g., LPDDR, LPDDR2, LPDDR3, or LPDDR4). In particular examples, a memory component may comply with a DRAM standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards (and similar standards) may be referred to as DDR-based standards and communication interfaces of the storage devices that implement such standards may be referred to as DDR-based interfaces. In various implementations, the individual memory devices may be of any number of different package types such as single die package (SDP), dual die package (DDP) or quad die package (Q17P). These devices, in some examples, may be directly soldered onto a motherboard to provide a lower profile solution, while in other examples the devices are configured as one or more memory modules that in turn couple to the motherboard by a given connector. Any number of other memory implementations may be used, such as other types of memory modules, e.g., dual inline memory modules (DIMMs) of different varieties including but not limited to microDIMMs or MiniDIMMs.

To provide for persistent storage of information such as data, applications, operating systems and so forth, a storage 1058 may also couple to the processor 1052 via the interconnect 1056. In an example, the storage 1058 may be implemented via a solid-state disk drive (SSDD). Other devices that may be used for the storage 1058 include flash memory cards, such as SD cards, microSD cards, XD picture cards, and the like, and USB flash drives. In an example, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magneto-resistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

In low power implementations, the storage 1058 may be on-die memory or registers associated with the processor 1052. However, in some examples, the storage 1058 may be implemented using a micro hard disk drive (HDD). Further, any number of new technologies may be used for the storage 1058 in addition to, or instead of, the technologies described, such resistance change memories, phase change memories, holographic memories, or chemical memories, among others.

The components may communicate over the interconnect 1056. The interconnect 1056 may include any number of technologies, including industry standard architecture (ISA), extended ISA (EISA), peripheral component interconnect (PCI), peripheral component interconnect extended (PCI-X), PCI express (PCIe), NVLink, or any number of other technologies. The interconnect 1056 may be a proprietary bus, for example, used in an SoC based system. Other bus systems may be included, such as an I2C interface, an SPI interface, point to point interfaces, and a power bus, among others.

The interconnect 1056 may couple the processor 1052 to a transceiver 1066, for communications with the connected edge devices 1062. The transceiver 1066 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. Any number of radios, configured for a particular wireless communication protocol, may be used for the connections to the connected edge devices 1062. For example, a wireless local area network (WLAN) unit may be used to implement Wi-Fi® communications in accordance with the Institute of Electrical and Electronics Engineers (IEEE) 802.11 standard. In addition, wireless wide area communications, e.g., according to a cellular or other wireless wide area protocol, may occur via a wireless wide area network (WWAN) unit.

The wireless network transceiver 1066 (or multiple transceivers) may communicate using multiple standards or radios for communications at a different range. For example, the edge computing node 1050 may communicate with close devices, e.g., within about 10 meters, using a local transceiver based on BLE, or another low power radio, to save power. More distant connected edge devices 1062, e.g., within about 50 meters, may be reached over ZigBee or other intermediate power radios. Both communications techniques may take place over a single radio at different power levels or may take place over separate transceivers, for example, a local transceiver using BLE and a separate mesh transceiver using ZigBee.

A wireless network transceiver 1066 (e.g., a radio transceiver) may be included to communicate with devices or services in the edge cloud 1090 via local or wide area network protocols. The wireless network transceiver 1066 may be an LPWA transceiver that follows the IEEE 802.15.4, or IEEE 802.15.4g standards, among others. The edge computing node 1050 may communicate over a wide area using LoRaWAN™ (Long Range Wide Area Network) developed by Semtech and the LoRa Alliance. The techniques described herein are not limited to these technologies but may be used with any number of other cloud transceivers that implement long range, low bandwidth communications, such as Sigfox, and other technologies. Further, other communications techniques, such as time-slotted channel hopping, described in the IEEE 802.15.4e specification may be used.

Any number of other radio communications and protocols may be used in addition to the systems mentioned for the wireless network transceiver 1066, as described herein. For example, the transceiver 1066 may include a cellular transceiver that uses spread spectrum (SPA/SAS) communications for implementing high-speed communications. Further, any number of other protocols may be used, such as Wi-Fi® networks for medium speed communications and provision of network communications. The transceiver 1066 may include radios that are compatible with any number of 3GPP (Third Generation Partnership Project) specifications, such as Long Term Evolution (LTE) and 5th Generation (5G) communication systems, discussed in further detail at the end of the present disclosure. A network interface controller (NIC) 1068 may be included to provide a wired communication to nodes of the edge cloud 1090 or to other devices, such as the connected edge devices 1062 (e.g., operating in a mesh). The wired communication may provide an Ethernet connection or may be based on other types of networks, such as Controller Area Network (CAN), Local Interconnect Network (LIN), DeviceNet, ControlNet, Data Highway+, PROFIBUS, or PROFINET, among many others. An additional NIC 1068 may be included to enable connecting to a second network, for example, a first NIC 1068 providing communications to the cloud over Ethernet, and a second NIC 1068 providing communications to other devices over another type of network.

Given the variety of types of applicable communications from the device to another component or network, applicable communications circuitry used by the device may include or be embodied by any one or more of components such as circuitry 1064, transceiver 1066, NIC 1068, or interface 1070. Accordingly, in various examples, applicable means for communicating (e.g., receiving, transmitting, etc.) may be embodied by such communications circuitry.

The edge computing node 1050 may include or be coupled to acceleration circuitry 1064, which may be embodied by one or more AI accelerators, a neural compute stick, neuromorphic hardware, an FPGA, an arrangement of GPUs, one or more SoCs, one or more CPUs, one or more digital signal processors, dedicated ASICs, or other forms of specialized processors or circuitry designed to accomplish one or more specialized tasks. These tasks may include AI processing (including machine learning, training, inferencing, and classification operations), visual data processing, network data processing, object detection, rule analysis, or the like. Accordingly, in various examples, applicable means for acceleration may be embodied by such acceleration circuitry.

The interconnect 1056 may couple the processor 1052 to a sensor hub or external interface 1070 that is used to connect additional devices or subsystems. The devices may include sensors 1072, such as accelerometers, level sensors, flow sensors, optical light sensors, camera sensors, temperature sensors, a global positioning system (GPS) sensors, pressure sensors, barometric pressure sensors, and the like. The hub or interface 1070 further may be used to connect the edge computing node 1050 to actuators 1074, such as power switches, valve actuators, an audible sound generator, a visual warning device, and the like.

In some optional examples, various input/output (I/O) devices may be present within or connected to, the edge computing node 1050. For example, a display or other output device 1084 may be included to show information, such as sensor readings or actuator position. An input device 1086, such as a touch screen or keypad may be included to accept input. An output device 1084 may include any number of forms of audio or visual display, including simple visual outputs such as binary status indicators (e.g., LEDs) and multi-character visual outputs, or more complex outputs such as display screens (e.g., LCD screens), with the output of characters, graphics, multimedia objects, and the like being generated or produced from the operation of the edge computing node 1050.

A battery 1076 may power the edge computing node 1050, although, in examples in which the edge computing node 1050 is mounted in a fixed location, it may have a power supply coupled to an electrical grid. The battery 1076 may be a lithium ion battery, or a metal-air battery, such as a zinc-air battery, an aluminum-air battery, a lithium-air battery, and the like.

A battery monitor/charger 1078 may be included in the edge computing node 1050 to track the state of charge (SoCh) of the battery 1076. The battery monitor/charger 1078 may be used to monitor other parameters of the battery 1076 to provide failure predictions, such as the state of health (SoH) and the state of function (SoF) of the battery 1076. The battery monitor/charger 1078 may include a battery monitoring integrated circuit, such as an LTC4020 or an LTC2990 from Linear Technologies, an ADT7488A from ON Semiconductor of Phoenix Arizona, or an IC from the UCD90xxx family from Texas Instruments of Dallas, TX. The battery monitor/charger 1078 may communicate the information on the battery 1076 to the processor 1052 over the interconnect 1056. The battery monitor/charger 1078 may also include an analog-to-digital (ADC) converter that enables the processor 1052 to directly monitor the voltage of the battery 1076 or the current flow from the battery 1076. The battery parameters may be used to determine actions that the edge computing node 1050 may perform, such as transmission frequency, mesh network operation, sensing frequency, and the like.

A power block 1080, or other power supply coupled to a grid, may be coupled with the battery monitor/charger 1078 to charge the battery 1076. In some examples, the power block 1080 may be replaced with a wireless power receiver to obtain the power wirelessly, for example, through a loop antenna in the edge computing node 1050. A wireless battery charging circuit, such as an LTC4020 chip from Linear Technologies of Milpitas, California, among others, may be included in the battery monitor/charger 1078. The specific charging circuits may be selected based on the size of the battery 1076, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

The storage 1058 may include instructions 1082 in the form of software, firmware, or hardware commands to implement the techniques described herein. Although such instructions 1082 are shown as code blocks included in the memory 1054 and the storage 1058, it may be understood that any of the code blocks may be replaced with hardwired circuits, for example, built into an application specific integrated circuit (ASIC).

In an example, the instructions 1082 provided via the memory 1054, the storage 1058, or the processor 1052 may be embodied as a non-transitory, machine-readable medium 1060 including code to direct the processor 1052 to perform electronic operations in the edge computing node 1050. The processor 1052 may access the non-transitory, machine-readable medium 1060 over the interconnect 1056. For instance, the non-transitory, machine-readable medium 1060 may be embodied by devices described for the storage 1058 or may include specific storage units such as optical disks, flash drives, or any number of other hardware devices. The non-transitory, machine-readable medium 1060 may include instructions to direct the processor 1052 to perform a specific sequence or flow of actions, for example, as described with respect to the flowchart(s) and block diagram(s) of operations and functionality depicted above. As used in, the terms “machine-readable medium” and “computer-readable medium” are interchangeable.

In further examples, a machine-readable medium also includes any tangible medium that is capable of storing, encoding or carrying instructions for execution by a machine and that cause the machine to perform any one or more of the methodologies of the present disclosure or that is capable of storing, encoding or carrying data structures utilized by or associated with such instructions. A “machine-readable medium” thus may include but is not limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. The instructions embodied by a machine-readable medium may further be transmitted or received over a communications network using a transmission medium via a network interface device utilizing any one of a number of transfer protocols (e.g., HTTP).

A machine-readable medium may be provided by a storage device or other apparatus which is capable of hosting data in a non-transitory format. In an example, information stored or otherwise provided on a machine-readable medium may be representative of instructions, such as instructions themselves or a format from which the instructions may be derived. This format from which the instructions may be derived may include source code, encoded instructions (e.g., in compressed or encrypted form), packaged instructions (e.g., split into multiple packages), or the like. The information representative of the instructions in the machine-readable medium may be processed by processing circuitry into the instructions to implement any of the operations discussed herein. For example, deriving the instructions from the information (e.g., processing by the processing circuitry) may include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions.

In an example, the derivation of the instructions may include assembly, compilation, or interpretation of the information (e.g., by the processing circuitry) to create the instructions from some intermediate or preprocessed format provided by the machine-readable medium. The information, when provided in multiple parts, may be combined, unpacked, and modified to create the instructions. For example, the information may be in multiple compressed source code packages (or object code, or binary executable code, etc.) on one or several remote servers. The source code packages may be encrypted when in transit over a network and decrypted, uncompressed, assembled (e.g., linked) if necessary, and compiled or interpreted (e.g., into a library, stand-alone executable, etc.) at a local machine, and executed by the local machine.

The block diagrams of FIGS. 10A and 10B are intended to depict a high-level view of components of a device, subsystem, or arrangement of an edge computing node. However, it will be understood that some of the components shown may be omitted, additional components may be present, and a different arrangement of the components shown may occur in other implementations.

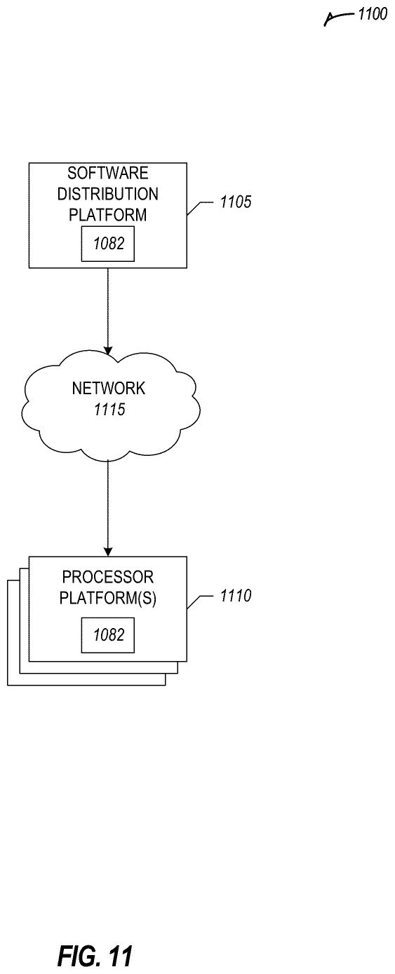

FIG. 11 illustrates an example software distribution platform 1105 to distribute software, such as the example computer readable instructions 1082 of FIG. 10B, to one or more devices, such as example processor platform(s) 1110 and/or other example connected edge devices or systems discussed herein. The example software distribution platform 1105 may be implemented by any computer server, data facility, cloud service, etc., capable of storing and transmitting software to other computing devices. Example connected edge devices may be customers, clients, managing devices (e.g., servers), third parties (e.g., customers of an entity owning and/or operating the software distribution platform 1105). Example connected edge devices may operate in commercial and/or home automation environments. In some examples, a third party is a developer, a seller, and/or a licensor of software such as the example computer readable instructions 1082 of FIG. 10B. The third parties may be consumers, users, retailers, OEMs, etc. that purchase and/or license the software for use and/or re-sale and/or sub-licensing. In some examples, distributed software causes display of one or more user interfaces (UIs) and/or graphical user interfaces (GUIs) to identify the one or more devices (e.g., connected edge devices) geographically and/or logically separated from each other (e.g., physically separated IoT devices chartered with the responsibility of water distribution control (e.g., pumps), electricity distribution control (e.g., relays), etc.).

In the illustrated example of FIG. 11, the software distribution platform 1105 includes one or more servers and one or more storage devices that store the computer readable instructions 1082. The one or more servers of the example software distribution platform 1105 are in communication with a network 1115, which may correspond to any one or more of the Internet and/or any of the example networks described above. In some examples, the one or more servers are responsive to requests to transmit the software to a requesting party as part of a commercial transaction. Payment for the delivery, sale and/or license of the software may be handled by the one or more servers of the software distribution platform and/or via a third-party payment entity. The servers enable purchasers and/or licensors to download the computer readable instructions 1082 from the software distribution platform 1105. For example, the software, which may correspond to example computer readable instructions, may be downloaded to the example processor platform(s), which is/are to execute the computer readable instructions 1082. In some examples, one or more servers of the software distribution platform 1105 are communicatively connected to one or more security domains and/or security devices through which requests and transmissions of the example computer readable instructions 1082 must pass. In some examples, one or more servers of the software distribution platform 1105 periodically offer, transmit, and/or force updates to the software (e.g., the example computer readable instructions 1082 of FIG. 10B) to ensure improvements, patches, updates, etc. are distributed and applied to the software at the end user devices.

In the illustrated example of FIG. 11, the computer readable instructions 1082 are stored on storage devices of the software distribution platform 1105 in a particular format. A format of computer readable instructions includes, but is not limited to a particular code language (e.g., Java, JavaScript, Python, C, C#, SQL, HTML, etc.), and/or a particular code state (e.g., uncompiled code (e.g., ASCII), interpreted code, linked code, executable code (e.g., a binary), etc.). In some examples, the computer readable instructions 1082 stored in the software distribution platform 1105 are in a first format when transmitted to the example processor platform(s) 1110. In some examples, the first format is an executable binary in which particular types of the processor platform(s) 1110 can execute. However, in some examples, the first format is uncompiled code that uses one or more preparation tasks to transform the first format to a second format to enable execution on the example processor platform(s) 1110. For instance, the receiving processor platform(s) 1100 may need to compile the computer readable instructions 1082 in the first format to generate executable code in a second format that is capable of being executed on the processor platform(s) 1110. In still other examples, the first format is interpreted code that, upon reaching the processor platform(s) 1110, is interpreted by an interpreter to facilitate execution of instructions.

What is claimed is:

1. A method of using fingerprint measurements for authentication of network use, the method comprising:
capturing in-phase and quadrature (IQ) data from a network connection between a user equipment (UE) and a cellular data network;
performing authentication of the network connection between the UE and the cellular data network using the IQ data; and
monitoring the IQ data on an ongoing basis to verify the network connection between the UE and the cellular data network.

2. The method of claim 1, wherein the cellular data network is a private 5G network, wherein the user equipment is capable of performing communications with a public 5G network and the private 5G network using respective SIM units, and wherein the use of the public 5G network or the private 5G network is based on: an application network selection function, a Quality of Service (QOS) selection and mapping function, or a security requirement.

3. The method of claim 1, further comprising:
creating a baseline IQ measurement from the IQ data when performing the authentication between the UE and the cellular data network; and
wherein monitoring the IQ data includes a comparison of an ongoing IQ measurement to the baseline IQ measurement.

4. The method of claim 3, further comprising:
identifying a degraded state of the network connection when the comparison of the ongoing IQ measurement to the baseline IQ measurement is outside a determined range.

5. The method of claim 4, wherein the determined range is identified based on use of a trained model.

6. The method of claim 1, wherein the authentication of the network connection is performed based on using a symbol of the IQ data as a random factor for the authentication.

7. The method of claim 1, wherein the authentication of the network connection is performed in response to a packet data unit (PDU) session establishment between the UE and the cellular data network.

8. The method of claim 1, wherein the in-phase and quadrature (IQ) data includes measurements captured from a reference signal transmitted between at least one antenna of the UE and at least one serving cell antenna of the cellular data network, and wherein the reference signal is an uplink sounding reference signal (SRS) or a downlink channel state information reference signal (CSI-RS).

9. The method of claim 1, wherein the method is performed by the UE, and wherein the authentication of the network connection between the UE and the cellular data network is further based on at least one identifier associated with the cellular data network or the UE.

10. The method of claim 9, further comprising:
assigning an application installed on the UE for exclusive connectivity with the cellular data network, based on the authentication of the network connection between the UE and the cellular data network and the at least one identifier associated with the cellular data network or the UE.

11. A device, comprising:
processing circuitry; and
a memory device including instructions embodied thereon, wherein the instructions, when executed by the processing circuitry, configure the processing circuitry to perform operations that:
obtain in-phase and quadrature (IQ) data from a network connection between a user equipment (UE) and a cellular data network;
perform authentication of the network connection between the UE and the cellular data network, using the IQ data; and
monitor the IQ data on an ongoing basis to verify the network connection between the UE and the cellular data network.

12. The device of claim 11, wherein the cellular data network is a private 5G network, wherein the user equipment is capable of performing communications with a public 5G network and the private 5G network using respective SIM units, and wherein the use of the public 5G network or the private 5G network is based on: an application network selection function, a Quality of Service (QOS) selection and mapping function, or a security requirement.

13. The device of claim 11, wherein the instructions further configure the processing circuitry to perform operations that:
create a baseline IQ measurement from the IQ data when performing the authentication between the UE and the cellular data network; and
wherein monitoring of the IQ data includes a comparison of an ongoing IQ measurement to the baseline IQ measurement.

14. The device of claim 13, wherein the instructions further configure the processing circuitry to perform operations that:
identify a degraded state of the network connection when the comparison of the ongoing IQ measurement to the baseline IQ measurement is outside a determined range.

15. The device of claim 14, wherein the determined range is identified based on use of a trained model.

16. The device of claim 11, wherein the authentication of the network connection is performed based on using a symbol of the IQ data as a random factor for the authentication.

17. The device of claim 11, wherein the authentication of the network connection is performed in response to a packet data unit (PDU) session establishment between the UE and the cellular data network.

18. The device of claim 15, wherein the in-phase and quadrature (IQ) data includes measurements captured from a reference signal transmitted between at least one antenna of the UE and at least one serving cell antenna of the cellular data network, and wherein the reference signal is an uplink sounding reference signal (SRS) or a downlink channel state information reference signal (CSI-RS).

19. The device of claim 11, wherein the operations are performed by the UE, and wherein the authentication of the network connection between the UE and the cellular data network is further based on at least one identifier associated with the cellular data network or the UE.

20. The device of claim 19, wherein the instructions further configure the processing circuitry to perform operations that:
assign an application installed on the UE for exclusive connectivity with the cellular data network, based on the authentication of the network connection between the UE and the cellular data network and the at least one identifier associated with the cellular data network or the UE.
